(19) United States
(12) Patent Application Publication
(10) Pub. No.: US 2014/0049028 A1
(43) Pub. Date: Feb. 20, 2014

(54) SEAT CUSHION AIRBAG

(71) Applicants: Steven J. Schenten, Oxford, MI (US); Slavko Kocevski, Rochester, MI (US); George J. Zamplas, Novi, MI (US); Ronald J. Rossio, Canton, MI (US)

(72) Inventors: Steven J. Schenten, Oxford, MI (US); Slavko Kocevski, Rochester, MI (US); George J. Zamplas, Novi, MI (US); Ronald J. Rossio, Canton, MI (US)

(21) Appl. No.: 13/967,563

(22) Filed: Aug. 15, 2013

Related U.S. Application Data
(60) Provisional application No. 61/684,193, filed on Aug. 17, 2012.

(51) Int. Cl. B60R 21/231; B60R 21/235

(52) U.S. Cl. CPC B60R 21/231; B60R 21/235
USPC 280/730.1

(57) ABSTRACT

A system for a vehicle may include an interior component, such as a seat assembly, for example, disposed in a passenger compartment of the vehicle. The interior component may include an expandable member that may be at least partially exposed to the passenger compartment. The expandable member may expand in response to an impact event from an undeployed state to a fully deployed state without breaking a seam of the expandable member.

### CROSS-REFERENCE TO RELATED APPLICATION

This application claims the benefit of U.S. Provisional Ser. No. 61/684,193, filed Aug. 17, 2012.

### FIELD

The present disclosure relates to an airbag for a vehicle, and more particularly, to a seat cushion airbag.

### BACKGROUND

A vehicle may include a seat or other interior component having an airbag that deploys in response to the vehicle being involved in a crash or other impact event. Typically, the airbag begins to inflate within the seat an continues to expand until a tear-seam on the seat bursts in response to pressure exerted thereon by the inflating airbag. An intensifier may be disposed within the seat and may channel the inflating airbag toward the tear-seam, thereby focusing forces exerted by the expanding airbag toward the tear-seam. Once the tear-seam bursts, the airbag may protrude through an opening in the seat defined by the burst tear-seam. The airbag may continue to inflate outside of the seat until the airbag is fully inflated.

### SUMMARY

In one form, the present disclosure provides a system for a vehicle. The vehicle may include a passenger compartment. The interior component may include an expandable member that is at least partially exposed to the passenger compartment. The expandable member may expand from an undeployed state to a fully deployed state without breaking a seam of the expandable member.

The system may include an inflator configured to selectively discharge a fluid in response to an impact event. The fluid may expand the expandable member from the undeployed state to the fully deployed state. In some embodiments, the inflator may discharge the fluid into an inflatable bag. The inflatable bag may expand the expandable member from the undeployed state to said fully deployed state.

In some embodiments, the expandable member may define a cavity. The inflatable bag may be disposed within the cavity in the undeployed state and in the fully deployed state.

In some embodiments, the interior component may include a seat assembly. In some embodiments, the seat assembly may be free from rips or tears when the expandable member is in the fully deployed position. In some embodiments, the expandable member may be a part of a seat-bottom cushion. In some embodiments, the seat assembly may be a rear seat assembly. In other embodiments, the expandable member may be a part of any other interior component of the vehicle such as a steering wheel, a dashboard, a headliner, a pillar, or a door panel, for example.

In some embodiments, the expandable member may include an expandable fabric material. In some embodiments, the expandable fabric material may include at least one of a cloth material, a leather material or a synthetic material.

In another form, the present disclosure provides a system for a vehicle. The system may include an interior component and an inflatable member. The interior component may include an expandable member that is at least partially exposed to a passenger compartment of the vehicle and defines a cavity. The inflatable member may be disposed within the cavity. The inflatable member may be inflatable from an undeployed state to a fully deployed state without breaking through a seam of the expandable member.

In some embodiments, the inflatable member may be disposed entirely within the cavity in both the undeployed state and the fully deployed state.

In some embodiments, the system may include an inflator configured to selectively discharge a fluid into the inflatable member in response to an impact event. The fluid may expand the inflatable member from the undeployed state to the fully deployed state.

In some embodiments, the interior component may include a seat assembly. In some embodiments, the expandable member may be a part of a seat-bottom cushion. In some embodiments, the seat-bottom cushion may be free from openings when the inflatable member is in the fully deployed position. In some embodiments, the interior component may include a seat frame supporting the seat-bottom cushion. The inflatable member may be disposed between the expandable member and the seat frame.

In some embodiments, the expandable member may expand from a first state to a second state as the inflatable member inflates from the undeployed state to the fully deployed state.

In some embodiments, the expandable member may include an expandable fabric material. The expandable fabric material may include at least one of a cloth material, a leather material or a synthetic material.

In another form, the present disclosure provides a seat that may include a seat cushion and an airbag module. The seat cushion may at least partially define a cavity. The airbag module may include an inflatable bag at least partially disposed within the cavity. The inflatable bag may be inflatable from an undeployed state to a fully deployed state without breaking a seam or stitching of the seat cushion. Because the seat and airbag module are configured to allow the airbag module to fully deploy without breaking a seam (e.g., a tear-seam) or other breakaway portion of the seat, the airbag module may not need to include an intensifier to route or focus forces of inflation of the inflatable bag within the seat.

Further areas of applicability of the present disclosure will become apparent from the detailed description, claims and drawings provided hereinafter. It should be understood that the summary and detailed description, including the disclosed embodiments and drawings, are merely exemplary in nature intended for purposes of illustration only and are not intended to limit the scope of the invention, its application or use. Thus, variations that do not depart from the gist of the disclosure are intended to be within the scope of the invention.

### BRIEF DESCRIPTION OF THE DRAWINGS

FIG. 1 is a partial perspective view of a vehicle having front and rear seat assemblies according to the principles of the present disclosure;

FIG. 2 is a partially cross-sectioned perspective view of the rear seat assembly of FIG. 1 having an airbag module;

FIG. 3 is a partial cross-sectional view of the rear seat assembly with the airbag module in an undeployed state; and

FIG. 4 is a partial cross-sectional view of the rear seat assembly with the airbag module in a fully deployed state.

### DETAILED DESCRIPTION

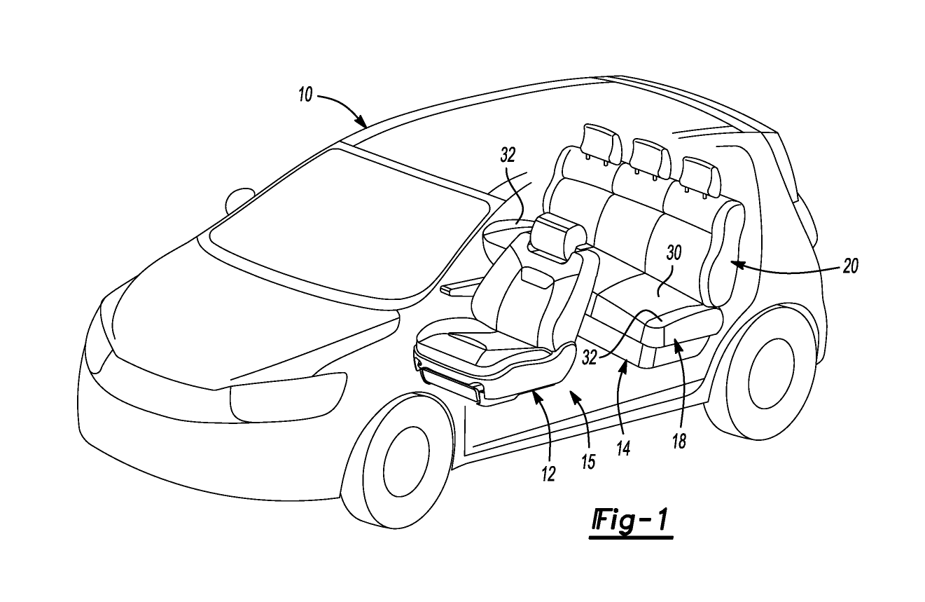

In an exemplary embodiment and with reference to FIGS. 1-4, a vehicle 10 is provided that may include a passenger compartment 15 having one or more front seats 12 and one or more rear seats 14 disposed therein. The vehicle 10 may be a car, minivan, van, sport-utility vehicle, crossover, or truck, for example, or any other type of vehicle. The rear seat 14 can be a second or third row seat, for example, or any other row behind the front seat 12 of the vehicle 10.

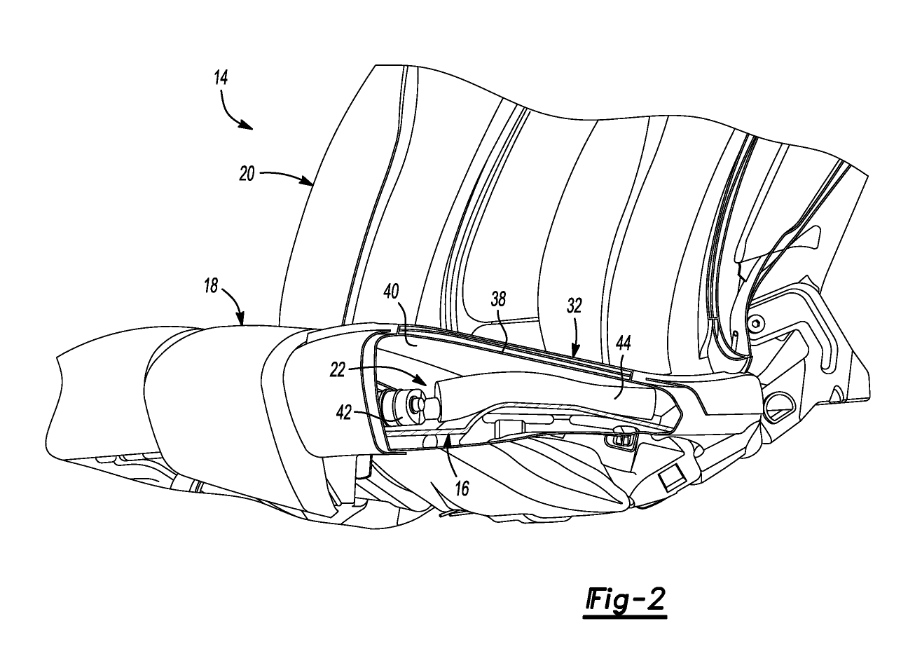

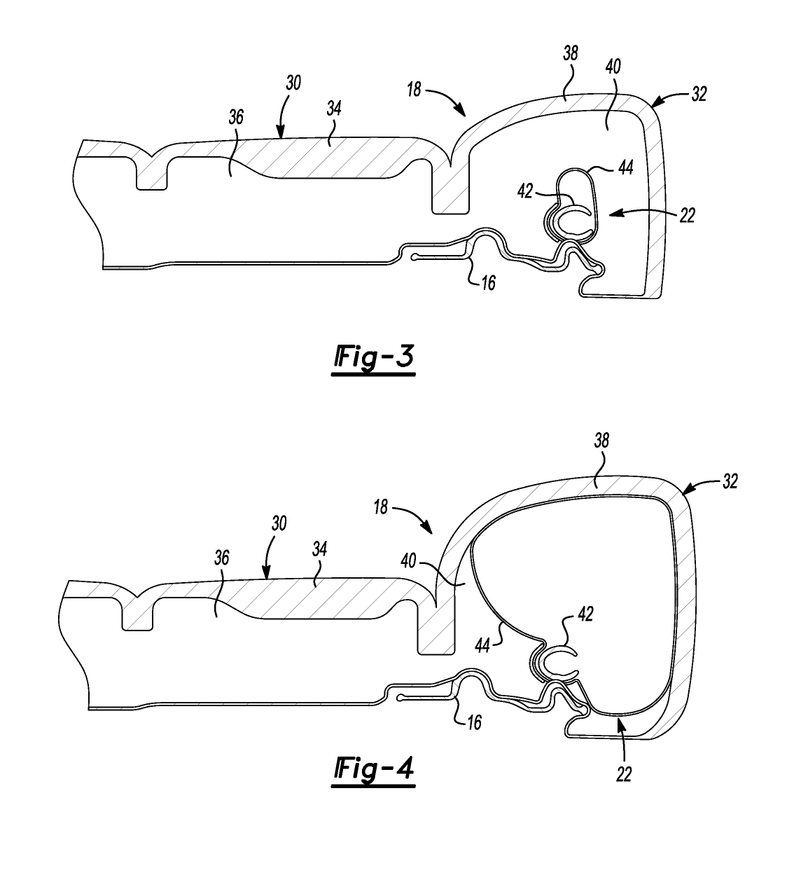

The rear seat 14 may include a seat frame 16, a seat-bottom cushion 18, a seatback cushion 20, and one or more airbag modules 22. The airbag module 22 may be inflatable from an undeployed state (shown in FIGS. 2 and 3) to a fully deployed state (shown in FIG. 4) in response to the vehicle 10 being involved in a crash or other impact event. As shown in FIG. 4, the airbag module 22 may be disposed entirely within the seat-bottom cushion 18 in both of the undeployed and fully deployed states. Accordingly, full deployment of the airbag module 22 can be achieved without breaking a seam of the seat-bottom cushion 18 or otherwise protruding outside of the seat-bottom cushion 18. While the airbag module 22 is shown in the figures as being disposed within the seat-bottom cushion 18 of the rear seat 14, it will be appreciated that the airbag module 22 could be disposed in any part of the front or rear seats 12, 14 or in any other interior component of the vehicle 10 such as a steering wheel, a dashboard, a headliner, a pillar, or a door panel, for example.

The seat-bottom cushion 18 may include a central portion 30 and outer portions 32 disposed adjacent the lateral ends of the central portion 30 and adjacent an interior wall or a rear door of the vehicle 10. The central portion 30 may include an outer layer 34 defining a cavity 36. The outer layer 34 may be formed from a fabric such as cloth, leather and/or synthetic upholstery, for example. The cavity 36 may be at least partially filled with a foam material, springs and/or any other resiliently compressible member to provide a comfortable sitting surface for the seat-bottom cushion 18.

Each outer portion 32 may include an expandable member 38 that cooperates with the seat frame 16 to define a cavity 40. The expandable member 38 may be secured to or integrally formed with the outer layer 34 of the central portion 30. The expandable member 38 may be formed from a stretchable or expandable fabric such as a cloth, leather, a synthetic material or any other compliant and expandable material. The expandable member 38 may be movable between an undeployed state (FIG. 3) and a fully deployed state (FIG. 4). The expandable member 38 may be the outermost layer of the seat-bottom cushion 18. It will be appreciated that in some embodiments, the outer portion 32 may include additional sheets of expandable fabric or upholstery outside of and/or inside of the expandable member 38 that may move with the expandable member 38 between the undeployed and fully deployed states. In some embodiments, a foam or other resiliently compliant material may be disposed within the cavity 40 to provide cushioning.

The airbag module 22 may include an inflator 42 and a cushion pack 44. The inflator 42 may be conventionally constructed and may be at least partially disposed in the cavity 40. The inflator 42 can be mounted to the seat frame 16, for example, or any other suitable rigid and stationary component. The inflator 42 may be configured to discharge a fluid (e.g., a gas and/or propellant) in response to sensors (not shown) on the vehicle 10 sensing one or more forces indicative of a crash or other impact event.

The cushion pack 44 may be a conventional inflatable bag formed from an expandable material. The cushion pack 44 may be configured to receive the fluid discharged from the inflator 42 to inflate the cushion pack 44 from the undeployed state (FIG. 3) to the fully deployed state (FIG. 4). It will be appreciated that when the cushion pack 44 is in the undeployed state, the cushion pack 44 may or may not be completely deflated.

With continued reference to FIGS. 1-4, operation of the rear seat 14 will be described. When a passenger is properly seated on the rear seat 14, the passenger may be sitting on the central portion 30 of the seat-bottom cushion 18. Depending on the size and position of the passenger, a portion of the passenger's leg and/or hip may be on or adjacent to the outer portion 32 of the seat-bottom cushion 18. When the vehicle 10 is involved in a crash or other impact event, the inflator 42 may rapidly discharge the fluid into the cushion pack 44 to inflate the cushion pack 44 from the undeployed state to the fully deployed state. In the fully deployed state, the cushion pack 44 and the expandable member 38 may expand outward between the passenger and a door or wall of the vehicle 10 and may absorb energy from the impact event to protect the passenger's legs, hips, and/or other body parts.

As the cushion pack 44 inflates to the fully deployed position, the expandable member 38 expands outward with the cushion pack 44 to the position shown in FIG. 4. Expansion of the cushion pack 44 to the fully deployed position may not break any seams in the expandable member 38 or the outer layer 34, rip or tear the expandable member 38 or the outer layer 34 or otherwise break through or burst the expandable member 38, the outer layer 34 or any other component of the rear seat 14. The cushion pack 44 may remain entirely within the cavity 40 in the undeployed state and in the fully deployed state.

Because there is no tear-seam or other breakaway portion of the seat-bottom cushion 18 that must burst, tear or otherwise break in response to expansion of the cushion pack 44, the airbag module 22 may not need to include an intensifier to focus or route the cushion pack 44 toward a particular location. Furthermore, because the cushion pack 44 does not have to break through a tear-seam or other breakaway portion of the seat-bottom cushion 18 and protrude through a predetermined location of the seat-bottom cushion 18 in order to fully deploy, there may be less of a likelihood that an out-of-position passenger will impede deployment of the airbag module 22, as the cushion pack 44 may expand around any impediments or obstacles.

These advantages of the principles of the present disclosure may reduce the cost and complexity of the airbag module 22 and the rear seat 14, and may also improve the safety and effectiveness of the airbag module 22. Furthermore, the aesthetic design of prior-art seats were constrained in that the location of tear-seams were dictated by requirements for proper deployment of prior-art seat cushion airbag modules. Because the seat-bottom cushion 18 of the present disclosure does not need to include seams in specific locations (or any seams at all) to allow for proper deployment of the airbag module 22, the aesthetic styling of the seat-bottom cushion 18 can include seamless designs or seam-locations and/or seam-configurations that may be prohibited by the functional requirements of prior-art systems.

What is claimed is:

1. A system for a vehicle having a passenger compartment, the system comprising an interior component including an expandable member that is at least partially exposed to the passenger compartment, said expandable member expanding from an undeployed state to a fully deployed state without breaking a seam of said expandable member.

2. The system of claim 1, further comprising an inflator configured to selectively discharge a fluid in response to an impact event, wherein said fluid expands said expandable member from said undeployed state to said fully deployed state.

3. The system of claim 2, wherein said inflator discharges said fluid into an inflatable bag, said inflatable bag expands said expandable member from said undeployed state to said fully deployed state.

4. The system of claim 3, wherein said expandable member defines a cavity, and wherein said inflatable bag is disposed within said cavity in said undeployed state and in said fully deployed state.

5. The system of claim 1, wherein said interior component includes a seat assembly.

6. The system of claim 5, wherein said seat assembly is free from tears when said expandable member is in the fully deployed position.

7. The system of claim 5, wherein said expandable member is a part of a seat-bottom cushion.

8. The system of claim 7, wherein said seat assembly is a rear seat assembly.

9. The system of claim 1, wherein said expandable member includes an expandable fabric material.

10. The system of claim 9, wherein said expandable fabric material includes at least one of a cloth material, a leather material or a synthetic material.

11. A system for a vehicle comprising:
an interior component including an expandable member that is at least partially exposed to a passenger compartment of the vehicle and defines a cavity; and
an inflatable member disposed within said cavity, said inflatable member being inflatable from an undeployed state to a fully deployed state without breaking through a seam of said expandable member.

12. The system of claim 11, wherein said inflatable member is disposed entirely within said cavity in both said undeployed state and said fully deployed state.

13. The system of claim 11, further comprising an inflator configured to selectively discharge a fluid into said inflatable member in response to an impact event, wherein said fluid expands said inflatable member from said undeployed state to said fully deployed state.

14. The system of claim 11, wherein said interior component includes a seat assembly.

15. The system of claim 14, wherein said expandable member is a part of a seat-bottom cushion.

16. The system of claim 15, wherein said seat-bottom cushion is free from openings when said inflatable member is in said fully deployed position.

17. The system of claim 15, wherein the interior component includes a seat frame supporting said seat-bottom cushion, and wherein said inflatable member is disposed between said expandable member and said seat frame.

18. The system of claim 11, wherein said expandable member expands from a first state to a second state as said inflatable member inflates from said undeployed state to said fully deployed state.

19. The system of claim 11, wherein said expandable member includes an expandable fabric material.

20. The system of claim 19, wherein said expandable fabric material includes at least one of a cloth material, a leather material or a synthetic material.
